(19) United States
(12) Patent Application Publication
(10) Pub. No.: US 2006/0249692 A1
(43) Pub. Date: Nov. 9, 2006

(54) Composite charged particle beam apparatus and an irradiation alignment method in it

(76) Inventor: Takashi Ogawa, Chiba-shi (JP)

Correspondence Address: BRUCE L. ADAMS, ESQ., SUITE 1231, 17 BATTERY PLACE, NEW YORK, NY, 10004, US

(21) Appl. No.: 11/410,600

(22) Filed: Apr. 25, 2006

(30) Foreign Application Priority Data
Apr. 26, 2005 (JP) 2005-127524

(51) Int. Cl. G01N 23/00

(52) U.S. Cl. 250/491.1

(57) ABSTRACT

An irradiation position positioning method of a charged particle beam in a composite charged particle beam apparatus having an ion beam lens barrel, a secondary charged particle and detector, is realized by irradiating a surface of a sample with a first charged particle beam, and irradiating the charged region with a second charged particle beam having a reverse charge, and observing a change in contrast between the charged region irradiated with the first charged particle beam and the charged region irradiated with the second charged particle beam under a microscope to position the second charged particle beam and identify a position irradiated with the second charged particle beam.

### BACKGROUND OF THE INVENTION

The present invention relates to an irradiation positioning method in a apparatus having a plurality of charged particle beam lens barrels and a composite charged particle beam apparatus having an irradiation positioning function.

A commonly called double-lens-barrel type composite charged particle beam apparatus is already known which has a separate electron beam and therefore an SEM observation function for observing the state of a sample subjected to etching and CVD through a focused ion beam (FIB) unit. In addition to a function for performing etching and CVD, the FIB unit has a function as an ion microscope for detecting a secondary charged particle such as a electron or ion emitted from the surface of an ion-irradiated sample and converting the amount of a secondary charged particle detected into an image (SIM image) at a position opposite to an position irradiated with the secondary charged particle. For the need of observing the cross-section construction at a desired portion of a semiconductor wafer or LSI device, a conventional FIB unit is used to make a hole through FIB-radiation-based etching from above the surface of a sample, incline a sample stage, irradiate the sample with FIB, and observe the cross-section of the sample. However, the above use of the apparatus requires the repetition of drilling-and-observation operations. Each drilling-and observation operation requires the FIB radiation angle and the sample stage to be changed for each such operation. Therefore, a proposal has been made of a system that performs drilling and microscope observation through two different beam radiations, that is, with two lens barrels disposed at different angles. For the basic configuration of the system, as shown in FIG. 14, an FIB lens barrel 1 and an SEM lens barrel are provided at different angles relative to a sample stage in a chamber 3, where a vacuum is attained. Each of the lens barrels is provided with blanking electrodes for switching beam radiations for controlling purposes. In addition, there is a secondary electron detector 4 provided near the sample stage (Refer to Patent Reference 1, for example). The cross-section drilling observation apparatus is intended to solve problematic points inherent to a conventional FIB unit. These problematic points include the operational trouble of having to reciprocating the sample stage several times for a drilling angle (usually horizontal) and an observation angle (ranging from 45° to about 60°), a mechanical error due to the movement of a sample, and the danger of overlooking minute foreign matter and an unusual shape due to the invisibility of the cross section of the sample being drilled. To solve the above-mentioned problematic points, the double-lens-barrel type composite charged particle beam apparatus has an ion beam radiation system 1 and an electron beam radiation system 2 for scanning and irradiation a surface of a sample with an ion beam and an electron beam, respectively, a detector 4 for capturing a secondary electron emitted from the sample irradiated with each of the ion beam and the electron beam, a display 26 for displaying an image of the sample based on an output of the detector, and a beam switching unit 33 for switching between the focused ion beam and the electron beam for sample irradiation. The ion beam radiation system 1 and the electron beam radiation system 2 are disposed at a right angle to a radiation axis thereof and at an angle smaller than a right angle to a radiation axis thereof, respectively. These systems are attached to a same sample chamber so that the systems can irradiate a same point on the sample with an ion beam and an electron beam, respectively. A beam blanking coil 30 shown in FIG. 14 is designed to blank an electron beam from the SEM lens barrel so that the sample is irradiated with the focused ion beam. Or a beam blanking coil electrode 23 shown in FIG. 14 is designed to blank an focused ion beam so that the sample is irradiated with the electron beam from the SEM lens barrel. As described above, the beam switching unit 33 switches between the ion beam and the electron beam. The image display unit displays an image of an image surface and an imaged of a drilled cross section in response to the switching operation of the switching unit 33.

The double-lens-barrel type composite charged particle beam apparatus described above eliminates the need of inclining and moving the sample stage for drilling and microscope observation as in a conventional FIB unit and is more advantageous in terms of operability and a mechanical error due to the movement of an sample. However, the double-lens-barrel type apparatus still requires the ion beam radiation system and the electron beam radiation system to irradiate on a same point on the sample with an ion beam and an electron beam, respectively. A recent double-lens-barrel type apparatus has required ion beam radiation to be minimized against damage to a sample due to ion beam radiation and its contamination.

A technique is disclosed in the patent reference 2 which involves observing a same registration mark through an ion beam and an electron beam, matching one field of vision with the other vision in advance by comparing an ion beam microscope image (SIM image) with an electron beam microscope image (SEM image), and performing drilling using an ion beam based on the SEM image only. Despite field-of-vision pre-matching already done on an actual sample, an electric field caused by a secondary electron detector and an electric charge on the surface of the sample raise a problem of misalignment between an electron beam and an ion beam depending on the position of the sample. Therefore, drilling using an ion beam entails invariably observing the SIM image and designating a drilling position.

In recent years, on the other hand, drilling using an ion beam has been performed without scanning a surface of a sample thanks to improvements in drilling performance. A technique for projecting a pattern formed at an aperture is, for example, described in the non-patent reference 1. In such an scanning-free ion beam drilling, positioning by means of a conventional technique is impossible because an ion beam microscope image cannot be obtained. A technique is described in the patent reference 3 for irradiating a portion of a sample which has been damaged due to an ion beam with an gas discharge type ion beam using a rare gas such as argon to eliminate damage to the sample. Because the large diameter of the above-mentioned gas discharge type ion beam, however, a resulting ion-beam microscope image is impossible to position.

[Patent Reference 1] JP-A-2-123749 “CROSS-SECTIONAL DRILLING OBSERVATION APPARATUS,” published on May 11, 1990, page 2, FIG. 3.

[Patent Reference 2] JP-A-10-92364 “FOCUSED ION BEAM DRILLING ALIGNMENT METHOD,” published on Apr. 10, 1998

[Patent Reference 3] JP-A-6-260129 “FOCUSED ION BEAM APPARATUS”, published on Sep. 16, 1994, page 6, FIG. 1.

[Non-Patent Reference 1] “Electron Ion Beam Handbook 3rd Edition,” published on Oct. 28, 1998, page 540, FIG. 15. 26.

[Non-Patent Reference 2] K. Ura and H. Fujioka “Electron Beam Testing,” Advanced In Electronics AND Electron Physics, Vol. 73, page 247, FIG. 8

An object of the present invention is to provide a composite charged particle beam apparatus that includes aligning an electron beam with an ion beam with minimum ion beam radiation and reduces damage due to an ion beam. Another object of the present invention is to provide a composite charged particle beam apparatus that allows designating the position of even an ion beam that is difficult to locate through an ion microscope observation.

### SUMMARY OF THE INVENTION

To solve the problems described above, an irradiation position positioning method of a charged particle beam in a composite charged particle beam apparatus having a plurality of charged particle beam lens barrels disposed in the same vacuum chamber in the present invention, comprises the steps of irradiating a surface of a sample with a first charged particle beam to charge the surface of the sample, irradiating a certain position within the charged region with a second charged particle beam having polarity opposite to that of the first charged particle beam to neutralize or reversely charge the certain position, and observing a change in contrast between the region irradiated and charged with the first charged particle beam and the region irradiated and charged with the second charged particle beam with a microscope by use of the first charged particle to identify an irradiation position of the second charged particle beam on the first charged particle beam image.

In the irradiation position positioning method in the composite charged particle beam apparatus, the first charged particle beam is an electron beam and the second charged particle beam is an ion beam. That is, the irradiation positioning method in a composite charged particle beam apparatus, according to the invention, includes irradiating a surface of a sample with an electron beam for a charged region, irradiating the charged region with a reverse-charge ion beam, and observing a change between the charged region irradiated with the electron beam and the charged region irradiated with the ion beam under a microscope using an SEM function to identify a position irradiated with the reverse-charge ion beam.

In the irradiation position positioning method in the composite charged particle beam apparatus, the first charged particle beam is a focused ion beam and the second charged particle beam is an electron beam. That is, the irradiation positioning method in a composite charged particle beam apparatus, according to the invention, includes irradiating a surface of a sample with an electron beam for a charged region, irradiating the charged region with a reverse-charge ion beam, and observing a change between the charged region irradiated with the electron beam and the charged region irradiated with the ion beam under a microscope using an SEM function to identify a position irradiated with the reverse-charge ion beam.

In the irradiation position positioning method in the composite charged particle beam apparatus, after the identification of the position irradiated with the second charged particle beam, the identified irradiated position relative to a center of a first charged particle image is calculated to thereby obtain a shift amount of an irradiated position of the second charged particle beam between in the first charged particle image and in a second charged particle image, and based on the obtained shift amount, a desired region to be irradiated with the second charged particle beam is designated on the first charged particle image.

In the irradiation position positioning method for a plurality charged particle beams in a composite charged particle beam apparatus having a plurality of charged particle beam lens barrels disposed in a same vacuum chamber, comprises the steps of irradiating a surface of a sample with a first charged particle beam for a charged region, irradiating the charged region with a second charged particle beam, observing a change in contrast between the charged region irradiated with the first charged particle beam and the charged region irradiated with the second charged particle beam under a microscope to identify a position irradiated with the second charged particle beam based on the first charged particle beam, and designating a desired region to be irradiated with the second charged particle beam on a first charged particle beam microscope image used for contrast change observation.

Further, a composite charged particle beam apparatus according to the present invention comprises, a first charged particle beam lens barrel; at least one second charged particle beam lens barrel for radiating a charged particle beam having a polarity opposite to that of the first charged particle beam; a secondary electron detector for detecting secondary electrons generated from a sample when the sample is irradiated with the charged particle beam; a vacuum chamber for housing the charged particle beam lens barrel and the secondary electron detector; each control power supply for each of the first and second charged particle beam lens barrel; a control computer for controlling the control power supply, processing signals from the secondary electron detector, storing the processed signals as image data together with position information corresponding to the signals, and outputting image signals based on the image data; and a display for inputting the image signals from the control computer and display an image;

wherein the control computer has means for irradiating a surface of a sample with a first charged particle beam to charge a certain region, irradiating a constant position within the charged region with a second charged particle beam, obtaining image data showing a change in contrast between the charged region irradiated with the first charged particle beam and the charged region irradiated with the second charged particle beam to identify the position irradiated with the second charged particle beam based on the image data obtained. That is, there is provided means for identifying a position irradiated with the second charged particle beam through the processing of a microscope image of the first charged particle beam for the charged region irradiated with the second charged particle beam.

In the composite charged particle beam apparatus, the control computer further comprises means for calculating the identified irradiation position relative to a center of a first charged particle image after the identification of the irradiation position of the second charged particle beam, to thereby obtain a shift amount of an irradiated position of the second charged particle beam between in the first charged particle image and in a second charged particle image, and designating a desired region to be irradiated with the second charged particle beam based on the obtained shift amount on the first charged particle image.

In the composite charged particle beam apparatus, either of the charged particle beam lens barrels is an ion beam lens barrel for radiating an ion beam, and the ion beam lens barrel is a focused ion beam lens barrel using a liquid metal ion source.

In the composite charged particle beam apparatus, either of the charged particle beam lens barrels is an ion beam lens barrel for radiating an ion beam, and the ion beam lens barrel is a variably formed ion beam lens barrel which projects an aperture pattern.

In the composite charged particle beam apparatus, the first charged particle beam lens barrel is an electron beam lens barrel, and the second charged particle beam lens barrel comprises a focused ion beam lens barrel using a liquid metal ion source and a gas discharge type lens barrel using a rare gas.

After the identification of the position irradiated with the second charged particle beam, the composite charged particle beam apparatus according to the invention calculates a distance of the identified irradiated position in the x and y direction from a center of a first charged particle image to thereby calculate an amount of shift between an irradiated position in the first charged particle image and an irradiated position in a second charged particle image and that based on the calculated amount of shift, a given region to be irradiated with the second charged particle beam is designated on the first charged particle image.

### ADVANTAGE OF THE INVENTION

The irradiation positioning method in a composite charged particle beam apparatus, according to the invention, includes irradiating a surface of a sample with a first charged particle beam, which is an electron beam or a positive-charge ion beam, for a highly charged region, irradiating the highly charged region with a second charged particle beam, which is a reverse-charge ion beam or an electron beam, observing a change between the charged region irradiated with the first charged particle beam and the charged region irradiated with the second charged particle beam under a microscope using the first charged particle beam to identify a position irradiated with the second charged particle beam. The method according to the present invention therefore requires simply performing beam spot radiation on a specific region and eliminates the need of scanning a surface of a sample. This makes it possible to reduce the quantity of charged particle beams with which an sample is irradiated.

The irradiation positioning method in a composite charged particle beam apparatus, according to the invention, includes irradiating a surface of a sample with an electron beam for a highly charged region, irradiating the highly charged region with a reverse-charge ion beam, and observing a change between the charged region irradiated with the electron beam and the charged region irradiated with the ion beam under a microscope using an SEM function to identify a position irradiated with the reverse-charge ion beam. The method according to the present invention therefore requires simply performing beam spot radiation on a specific region and eliminates the need of scanning a surface of a sample. This makes it possible to reduce the quantity of charged particle beams with which an sample is irradiated and damage to portions other than a target portion on the sample due to ion beam radiation.

The irradiation positioning method in a composite charged particle beam apparatus, according to the invention, includes irradiating a surface of a sample with a positive-charge ion beam for a positively, highly charged region, irradiating the highly charged region with a reverse-charge electron beam, and observing a change between the highly charged region irradiated with the positive-charge ion beam and the highly charged region irradiated with the reverse-charge electron beam under a microscope using an FIB function to identify a position irradiated with the electron beam. The method according to the present invention therefore requires simply performing beam spot radiation on a specific region and eliminates the need of scanning a surface of a sample. This makes it possible to reduce the quantity of charged particle beams with which an sample is irradiated and damage to and contamination of portions other than a target portion on the sample due to ion beam radiation.

The irradiation positioning method in a composite charged particle beam apparatus, according to the invention, includes irradiating a surface of a sample with a first charged particle beam, which is an electron beam or a positive-charge ion beam, for a charged region, irradiating the charged region with a second charged particle beam, which is a reverse-charge ion beam or an electron beam, observing a change between the highly charged region irradiated with the first charged particle beam and the charged region irradiated with the second charged particle beam under a microscope using the first charged particle beam to identify a position irradiated with the second charged particle beam, and designating the position irradiated with the second charged particle beam based on a microscope image of the first charged particle beam. The method according to the present invention therefore requires simply performing beam spot radiation on a specific region and eliminates the need of scanning a surface of a sample. This makes it possible to designate the position to be irradiated with the second charged particle beam with a minimum quantity of second charged particle beams with which portions other than a target portion in the sample is irradiated.

The irradiation positioning method in a composite charged particle beam apparatus, according to the invention, includes irradiating a surface of a sample with a first charged particle beam, which is an electron beam or a positive-charge ion beam, for a charged region, irradiating the highly charged region with a second charged particle beam, which is a reverse-charge ion beam or an electron beam, and observing a change between the charged region irradiated with the first charged particle beam and the charged region irradiated with the second charged particle beam under a microscope using the first charged particle beam to identify a position irradiated with the second charged particle beam through the processing of a microscope image of the first charged particle beam. This makes it possible to identify the position irradiated with the second charged particle beam with a minimum quantity of second charged particle beams with which portions other than a target portion in the sample is irradiated irrespective of how familiar a user is with the apparatus.

The composite charged particle beam apparatus according to the present invention has a first charged particle beam lens barrel, a second charged particle beam lens barrel for radiating a charged particle beam having a polarity opposite to that of the first charged particle beam, a secondary electron detector for detecting a secondary electron generated from a sample when the sample is irradiated with the charged particle beam, a vacuum chamber for housing the charged particle beam lens barrel and the secondary electron detector, a control power supply for each of the first and second charged particle beam lens barrel, a control computer for controlling the control power supply, processing a signal from the secondary electron detector, and storing the signal as image data together with data processed from the signal and a position irradiated with a beam and corresponding to the signal, and a display for inputting an image signal from the control computer based on the image data and display an image. The apparatus according to the present invention has a function for irradiating a surface of a sample with a first charged particle beam for a charged region, irradiating the charged region with a second charged particle beam, obtaining image data showing a change in contrast between the charged region irradiated with the first charged particle beam and the charged region irradiated with the second charged particle beam to identify the a position irradiated with the second charged particle beam based on the image data obtained. This makes it possible to configure a composite charged particle beam apparatus that allows identifying the position irradiated with the second charged particle beam with a minimum quantity of second charged particle beams with which portions other than a target portion in the sample is irradiated with no load on a user of the apparatus.

The composite charged particle beam apparatus according to the invention irradiates a surface of a sample with an electron beam or a positive-charge ion beam for a charged region, irradiates the charged region with a reverse-charge ion beam or an electron beam, and observes a change between the charged region irradiated with the electron beam or positive-charge ion beam and the charged region irradiated with the reverse-charge ion beam or electron beam under a microscope for analysis. The composite charged particle beam apparatus according to the invention uses a liquid metal ion source as an positive-charge ion beam. This makes it possible to perform minute machining such as drilling in a specific position by narrowing an ion beam and to configure an composite charged particle beam apparatus that designates a position to be irradiated with an ion beam with minimum damage to a sample.

The composite charged particle beam apparatus according to the invention also irradiates a surface of a sample with an electron beam or a positive-charge ion beam for a charged region irradiates the highly charged region with a reverse-charge ion beam or an electron beam, and observes a change between the charged region irradiated with the electron beam or positive-charge ion beam and the charged region irradiated with the reverse-charge ion beam or electron beam under a microscope for analysis. The method according to the present invention therefore requires simply performing beam spot radiation on a specific region and eliminates the need of scanning a surface of a sample. This makes it possible to position an ion beam without scanning as with a variably formed ion beam. In addition, it is possible to designate a drilling position for a variably formed ion beam, which is difficult to position, by designating a drilling position for an ion beam using an electron beam.

The composite charged particle beam apparatus according to the invention also irradiates a surface of a sample with an electron beam or a positive-charge ion beam for a charged region, irradiates the highly charged region with a reverse-charge ion beam or an electron beam, and observes a change between the charged region irradiated with the electron beam or positive-charge ion beam and the charged region irradiated with the reverse-charge ion beam or electron beam under a microscope for analysis. The apparatus according to the present invention therefore requires simply performing beam spot radiation on a specific region and eliminates the need of scanning a surface of a sample. It is therefore possible to position even a broad ion beam such as a gas discharge type ion beam using a rare gas represented by an argon ion beam. It is also possible to designate a position to be drilled with a gas discharge type ion beam using a rare gas, which is difficult to position, by designating a position be to drilled with a ion beam using an electron beam.

### BRIEF DESCRIPTION OF THE DRAWINGS

FIG. 1 is a diagram showing the basic configuration of a positioning method according to the present invention.

FIG. 2 is a diagram describing the condition of a electrically charged sample according to the present invention using an electron charge.

FIG. 3 is a diagram describing the condition of a electrically charged sample according to the present invention using a positive ion charge.

FIG. 4 is a diagram describing the positioning method according to the invention.

FIG. 5 is a diagram describing the positioning method according to the invention.

FIG. 6 is a diagram describing the positioning method according to the invention.

FIG. 7 is a diagram showing the basic configuration of an apparatus implementing the positioning method according to the invention.

FIG. 8 is a diagram showing the inside function of the apparatus implementing the positioning method according to the invention.

FIG. 9 is a diagram showing the inside function of the apparatus implementing the positioning method according to the invention.

FIG. 10 is a diagram showing an ion lens barrel having a liquid metal ion source mounted in the apparatus implementing the positioning method according to the invention.

FIG. 11 is a diagram showing an ion lens barrel having a variably formed beam method mounted in the apparatus implementing the positioning method according to the invention.

FIG. 12 is a diagram describing a variably formed beam method and a focused ion beam.

FIG. 13 is a diagram describing a configuration having a focused ion lens barrel and anion lens barrel using a rare gas ion source in the apparatus implementing the positioning method according to the invention.

FIG. 14 is a diagram describing a conventional example.

FIG. 15 is a conventional example describing potential contrast according to the present invention.

FIG. 16 is a diagram describing potential contrast, which is a basic phenomenon according to the present invention.

### DESCRIPTION OF THE REFERENCE NUMERALS AND SIGNS

1: FIB lens barrel
2: SEM lens barrel
3: Vacuum chamber
4: Secondary electron detector
5: Control computer
6: Positioning means
7: Positioning mechanism
8: FIB power supply
9: SEM power supply
10: Sample
11: FIB lens barrel having liquid metal ion source
12: Positioning software
13: ion beam lens barrel irradiating variably formed ion beam
14: Aperture plate having the aperture of an arbitrary shape
15: Aperture
16: CL
17: OL
18: Ion beam lens barrel using a gas discharge type ion source
19: Probe

### DETAILED DESCRIPTION OF THE INVENTION

The present invention relates to a function of aligning a position irradiated with an electron beam with a position irradiated with an ion beam in a composite apparatus having both a scanning electronic microscope (SEM) and a focused ion beam (FIB) unit. A commonly called double-lens-barrel type composite charged particle beam apparatus having an electron beam lens barrel and an ion beam lens barrel has been so far in practical use as a system that allows quick and high accurate drilling in the form that fabrication of the sample carried out by FIB is observed by SEM (Refer to Patent Reference 1). The present invention is based on a complete new technical concept that a position irradiated with an electron beam is aligned with a position irradiated with an ion beam taking advantage of the fact that an electron has an electric charge opposite to that of an ion when a positive ion is used as an ion source in a similar composite SEM/FIB apparatus.

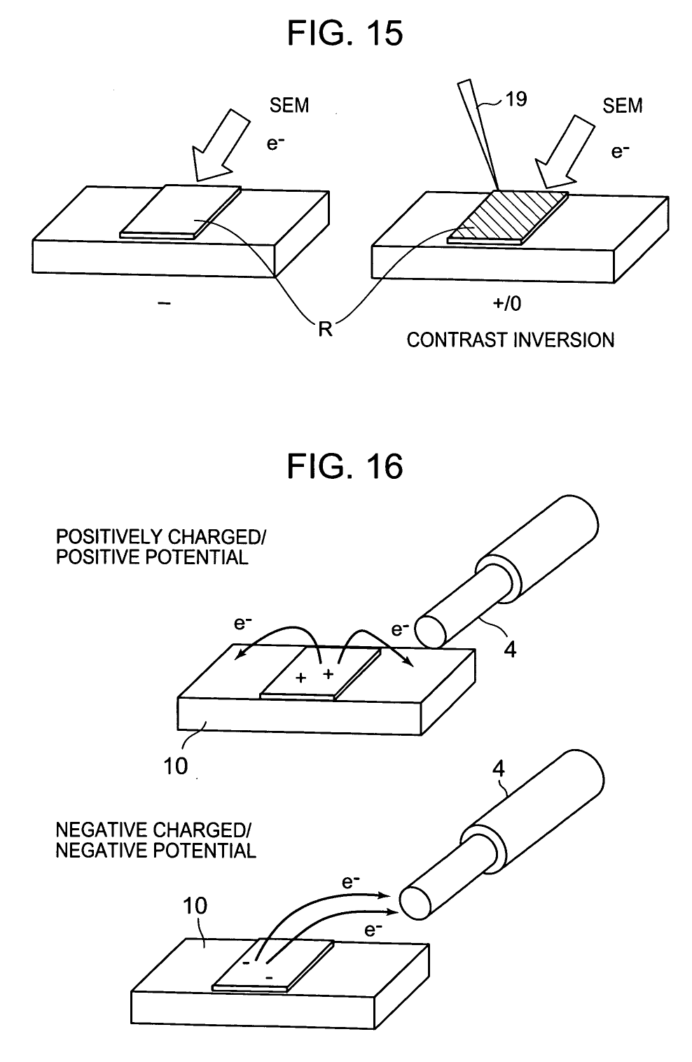

The principle of the invention is based on a change between a highly charged region irradiated with a electron beam or positive charge ion beam in advance and the highly charged region irradiated with a reverse-charge ion beam or electron beam, which change will appear in a microscope image. This phenomenon will be described in detail. Contrast (potential contrast) is disclosed in the non-patent reference 2, which appears through contact a conductive probe with a semiconductor device with a similar principle to the phenomenon. In a SEM unit having a conductive probe in a system, contact of the probe with a local portion of a sample during observation causes the local portion to turn on or off, which phenomenon is seen on a display. The phenomenon is called potential contrast. It is assumed, as shown on the left side in FIG. 15, that when observing a surface of a sample with a wire R exposed on the surface due to SEM, the R portion of the wire is displayed bright in an SEM image observed. The moment a conductive probe 19 comes into contact with the R portion of the wire displayed bright, the R portion becomes dark as shown on the right side in FIG. 15. This happened for the following reason: in the SEM observation, the surface of the sample is irradiated with an negatively charged electron, which is then on the R portion of the wire and is discharged because of the contact of the conductive probe 19 with the portion, thus resulting in a change in the potential of the portion. A secondary electron is discharged in response to the properties of a portion irradiated with an electron beam during the scanning of the surface of a sample with electron beam, for example, like a raster. The second electron then corresponds to a position irradiated with the electron beam and an SEM observation image is displayed two-dimensionally. As shown on the top in FIG. 16, it is assumed that some region of a sample is positively charged. When the sample is irradiated with an electron beam, a negatively charged secondary electron is discharged. The secondary electron is attracted to the region, thus making it difficult for the secondary electron to reach a secondary electron detector (SED) The secondary electron is therefore difficult to detect. An image cover the region looks darker. In contrast, it is assumed that some region of a sample is negatively charged, as shown on the bottom side in FIG. 16. When the sample is irradiated with an electron beam, a secondary electron is discharged. The secondary electron is pushed in the direction of the secondary electron detector because of a repulsive force generated by the electric charge present the region, thus making it easy for the secondary electron to be detected. The image covering the region therefore looks brighter.

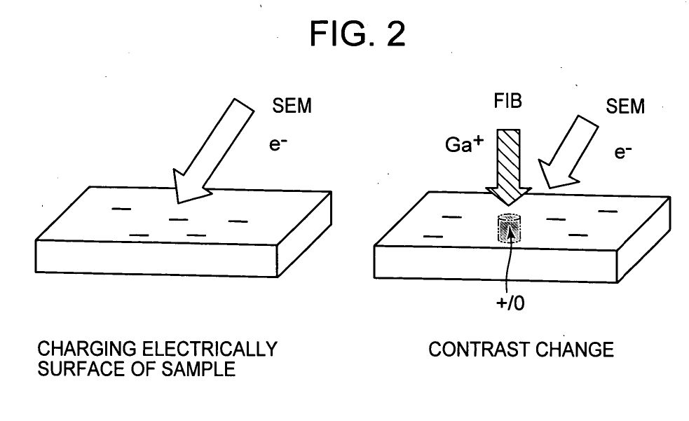

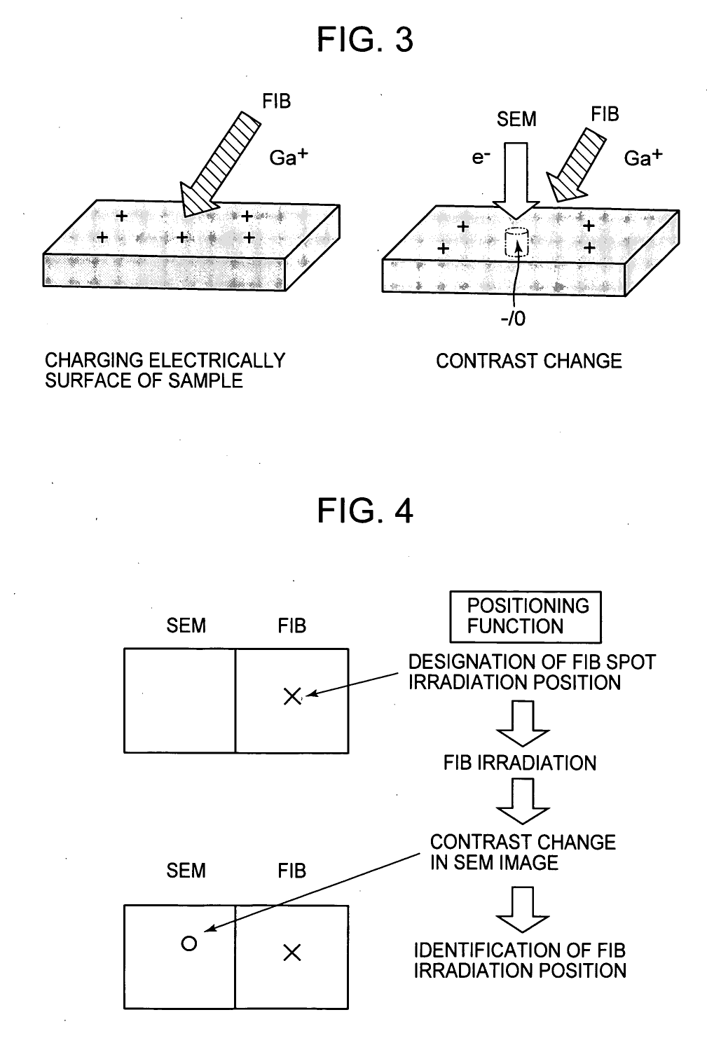

The basic principle of the invention is based on the observation of potential change on a sample due to a spot irradiation of the sample with an ion beam having a different positive or negative charge in place of the probe shown in FIG. 15. FIGS. 2 and 3 are diagrams for describing the above-mentioned basic principle. These diagrams will be described in an embodiment which will be described later.

An irradiation positioning method according to the present invention will be described below in detail. The description of the method first starts with electrically charging a sample. The sample may be electrically charged using an electron beam or an ion beam. If the sample is electrically charged using an electron beam, the surface of the same will be observed using a large beam current (nA or so) of an SEM. The surface of the sample is negatively charged by irradiating the sample with an electron beam having a large current (step 1). The way the sample is electrically charged varies depending on the construction of the sample. After contrast change is clear because of the electrical charging of the sample, an appropriate portion of the electrically charged portion is then spot irradiated with an ion beam for positive-charge pouring purposes (step 2). During ion radiation, the condition of the sample is then observed under the SEM (step 3). On an SEM image a portion irradiated with the ion beam can be observed as changing contrast against a surrounding region thereof. The relation between the positions of the electron beam and the ion beam can therefore be detected (step 4).

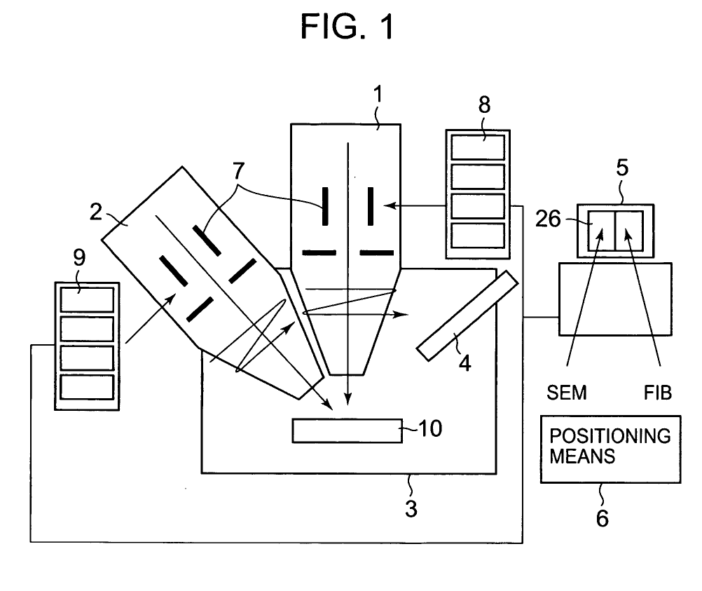

The basic configuration of the apparatus for performing a beam position adjustment method according to the present invention is now shown in FIG. 1. Reference numeral 1 depicts an FIB lens barrel, 2 an SEM lens barrel, 3 a vacuum chamber, 4 a secondary electron detector, 5 a computer for controlling the present apparatus, 6 an SEM and FIB positioning unit provided in the control computer 5, 26 a display, 7 an alignment mechanism utilizing a beam deflection function through an electric field or a magnetic field provided in the FIB lens barrel and the SEM lens barrel, 8 a power supply for an FIB, and 9 a power supply for an SEM.

The flow described above will be described below with reference with the configuration diagram.

Step 1

Settings are input into a computer 5 through input means such as a keyboard. These settings relate to the selection of an electron or an ion to electrically charge a sample and the magnitude of a beam current. In response to the settings input, the computer 5 then sends information on the settings to a power supply 8 for an FIB in the FIB lens barrel 1 or a power supply 9 for an SEM in an SEM lens barrel 2. The computer 5 thereby irradiates the sample with a charged particle and electrically charges and observes the sample. The electrical charging of the sample with an electron through the electron beam radiation system 2 selected will be described below. The observation of a large current present on the sample will make contrast change clear after the sufficient electric charging of the sample.

Step 2

Subjected to a scanning command from the computer 5, the SEM lens barrel 2 performs electron beam scanning for observation under a microscope. The electron beam then discharge a secondary electron from a position irradiated therewith, which is then detected by the secondary electron detector 4, which then sends the detected value and positional data to the computer for storage. After storing data on the scanned region, the computer 5 then outputs the stored data as image information to a display, which then displays a present sample image.

Step 3

An operator then decides and specifies an appropriate portion of the sample image using input means such as a mouse on a display. The computer 5 then sends the positional information to the FIB lens barrel, which has a charge-neutralizing electric charge. On receipt of a signal from the computer 5, the FIB lens barrel then adjusts a deflector so that an beam impinges on a target portion. The FIB lens barrel then irradiates the sample with an ion beam at a specified acceleration voltage for reverse-charge pouring.

Step 4

The electron beam lens barrel is then operated with a microscope function under the control of the computer 5. The condition of the sample is observed under the SEM when he sample is irradiated with the ion beam at step 3. As described earlier, a position irradiated with the ion beam appears on an SEM image as changing contrast.

Step 5

The computer 5 then analyzes the SEM image and identifies a position spot irradiated with the FIB. Then computer 5 then calculates the position relative to the center of the SEM image to the FIB-irradiated position to determine a shift between the irradiated position from the FIB lens barrel and the irradiated position from the SEM lens barrel.

Step 6

The computer 5 then converts the positional shift thus obtained into the amount of deflection for the FIB lens barrel, which has a neutralizing electric charge before storage in the memory.

Step 7

The computer 5 then sends the stored amount of deflection to the FIB lens barrel. On receipt of a signal from the computer, the FIB lens barrel then adjusts the deflector so that the beam impinges on the center of the SEM lens barrel.

Step 8

For drilling with an FIB during SEM image observation, the computer 5 then converts a drilling position specified by the SEM image into a position for drilling for an FIB according to the amount of deflection stored in the memory. The computer 5 then sends a signal indicating the drilling position thus obtained to the FIB lens barrel. On receipt of the signal, the FIB lens barrel irradiates the specified drilling position with a beam to perform the drilling of the sample.

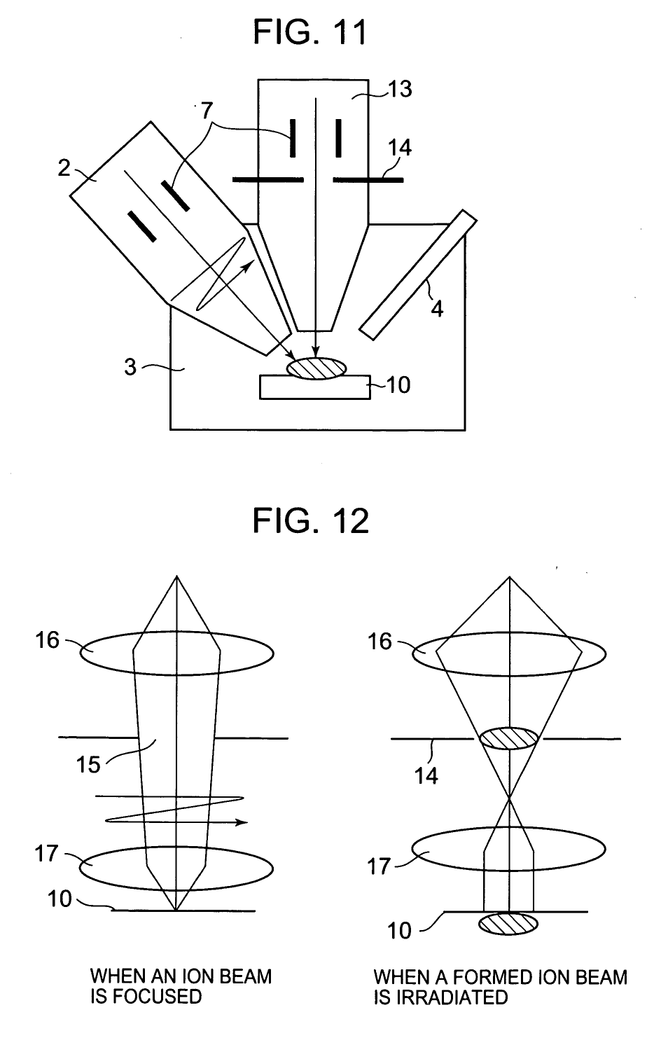

As one of the aspects different from the above description, a similar flow is applicable even if the FIB is replaced with a variably formed ion beam used for projecting the image of an aperture. FIG. 11 shows a diagram for describing a variably formed ion beam used for projecting the image of an aperture in place of an FIB used for usual sample scanning. In the FIB, an ion beam is focused on the sample and drilling is performed on a specific region by scanning the region using a deflection electrode. In the variably formed ion beam shown in FIG. 11, the image of an aperture is projected on the sample without scanning. The aperture can be of any shape such as circle and rectangle. Even in the above-mentioned variably formed ion beam, an apparatus having the function described above is possible. In the apparatus described above, the addition of function and flow described above will allow the adjustment of the position of the beam or the designation of a drilling region using an SEM image.

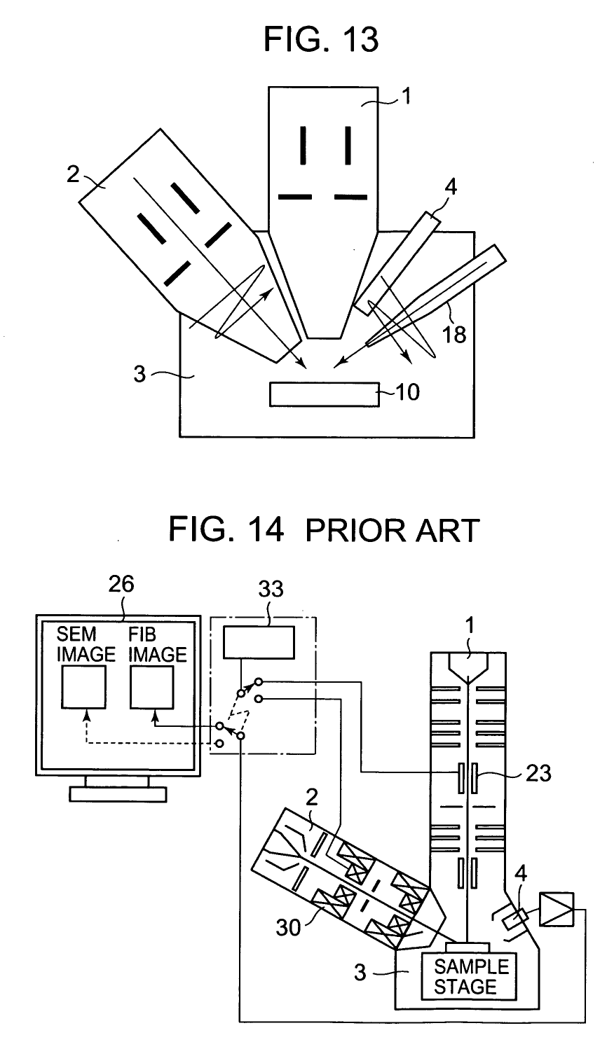

As another one of the aspects different from the above description, there is a composite FIB/SEM apparatus available which has an additional gas discharge type ion beam lens barrel using a rare gas besides the FIB lens barrel. FIG. 13 shows a diagram for describing a composite FIB/SEM apparatus has an additional gas discharge type ion beam lens barrel using a rare gas. In the gas discharge type ion beam lens barrel using a rare gas, it is difficult to adjust the position of the beam because of the large diameter of the beam with a microscope image alone which is obtained by scanning the beam. In this apparatus, the addition of a system having the function and flow described above permits a gas ion beam to be focused on a SEM-scanned region, thus making it possible to adjust the position of the beam by observing changing contrast that appears in the SEM image. The measurement of the relative position between the SEM and the gas ion beams makes it possible to designate a drilling region using the SEM image.

### First Embodiment

FIG. 1 shows a composite charged particle beam apparatus used for a positioning method according to the present invention. FIG. 1 shows the basic configuration of the apparatus. FIB lens barrel 1 and SEM lens barrel 2 are disposed in the same vacuum chamber. Both FIB lens barrel 1 and SEM lens barrel 2 are each controlled by a computer 5, an FIB control power supply 8, and an SEM control power supply 9. The apparatus has a positioning mechanism (deflector) 7 for irradiating the same position with an FIB and an SEM. The electron beam for an SEM is set to have a large current, the surface of a sample is scanned, the sample is negatively charged, and a resulting microscope image is observed. The condition of the sample electrically charged is shown on the left in FIG. 2. Then move the cursor to some region on the microscope image and click the mouse. The control computer 5 then reads and sends the positional information to the FIB lens barrel 1. On receipt of the positional information, the FIB lens barrel 1 controls a deflection mechanism so that the region is irradiated with the beam. The region is then irradiated with a positive ion such as Ga⁺ using the set beam current. During the observation of the SEM, contrast change then appears at a position irradiated with an FIB. The condition of the position irradiated with the FIB is shown on the right in FIG. 2. The position irradiated with the ion beam can be identified by measuring contrast changing position shown by the imaginary line in the SEM image.

### Second Embodiment

FIG. 3 shows an example where an FIB is used for electric charging and observation and, an electron beam is used for neutralizing or reversely charging a certain position within the area that has been charged by the FIB. The surface of the sample is positively charged by irradiating the sample with a positive ion such as Ga⁺. The wired portion of the sample consequently has a high potential and a secondary electron discharged by FIB radiation is attracted to the sample side, thus making it difficult for the secondary electron to reach the secondary electron detector 4. As shown on the left in FIG. 3, the wired portion therefore looks darker than the surrounding portion of a substrate. When the cursor is moved to some region on the microscope image and the mouse is clicked, the control computer 5 reads and sends the positional information to the SEM lens barrel 2. On receipt of the positional information, the SEM lens barrel 2 controls a deflection mechanism so that the region is irradiated with the beam. The region is then irradiated with an electron beam using the beam current. During observation under a scanning type ion microscope (SIM), changing contrast then appears at a position irradiated with the electron beam. The condition of the regions irradiated is shown on the right in FIG. 3. The position irradiated with the ion beam can be identified by measuring the position with changing contrast in the SEM image.

### Third Embodiment

FIG. 4 shows a diagram for describing an alternative embodiment of the positioning method according to the invention. The basic configuration of the apparatus is the same as in FIG. 1. In FIG. 4 a screen in a control computer is shown. The electron beam for an SEM is set to have a large current, the surface of a sample is scanned, the sample is negatively charged, and a resulting SEM image is observed. The condition of the sample electrically charged is shown on the left in FIG. 4. Then move the cursor to some region on the FIB microscope image and click the mouse. The computer 5 then reads and sends the positional information to the FIB lens barrel 1. On receipt of the positional information, the FIB lens barrel 1 controls a deflection mechanism so that the region is irradiated with the beam. The region is then irradiated with a positive ion such as Ga⁺ using the set beam current. During the observation of the SEM, changing contrast then appears at a position irradiated with an FIB. The condition of the regions irradiated is shown on the SEM image on the bottom left in FIG. 4. The amount of shift between the position irradiated with the ion beam or of the ion beam and the position of the electron beam can be identified by measuring the position with changing contrast in the SEM image.

### Fourth Embodiment

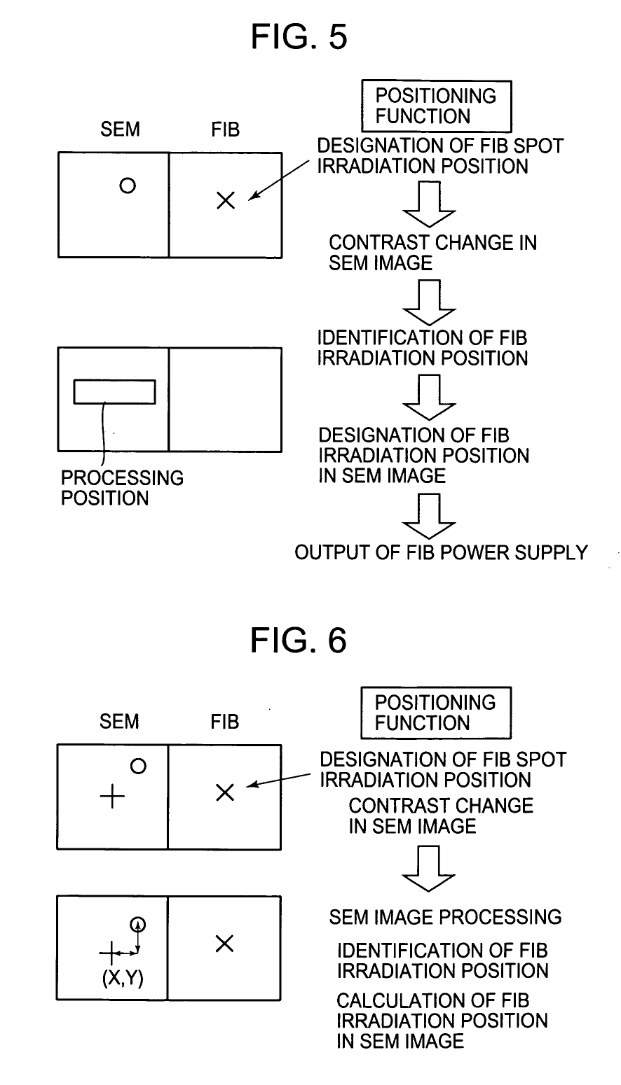

FIG. 5 shows a diagram for describing an alternative embodiment of the positioning method according to the invention. The basic configuration of the apparatus is the same as in FIG. 1. In FIG. 5 a screen in a control computer is shown. The electron beam for an SEM is set to have a large current, the surface of a sample is scanned, the sample is negatively charged, and a resulting SEM image is observed. Then move the cursor to some region on the FIB microscope image and click the mouse. The computer 5 then reads and sends the positional information to the FIB lens barrel 1. On receipt of the positional information, the FIB lens barrel 1 controls a deflection mechanism so that the region is irradiated with the beam. The region is then irradiated with a positive ion such as Ga⁺ using the set beam current. During the observation of the SEM, changing contrast then appears at a position irradiated with an FIB. The condition of the regions irradiated is shown on the SEM image on the top left in FIG. 5. The amount of shift between the position irradiated with the ion beam or the ion beam and the position of the electron beam can be identified by measuring the position with changing contrast in the SEM image. Using information thus obtained, a drilling position to be irradiated with an ion beam is designated in the SEM image. The condition of the drilling position designated is shown on the bottom left in FIG. 5. The control computer calculates coordinates for ion beam radiation based on the amount of shift between the position of the ion beam and the position of the electron measured from the position designated in the SEM image. Outputting these coordinates to the FIB power supply makes it possible to provide a function of irradiating a sample with an ion beam.

### Fifth Embodiment

FIG. 6 shows a diagram for describing an alternative embodiment of the positioning method according to the invention. The basic configuration of the apparatus is the same as in FIG. 1. In FIG. 6 a screen in a control computer is shown. The screen shown on the left in FIG. 6 is a screen for displaying and operating the SEM image. The + mark refers to the center of the SEM image. The screen shown on the right in FIG. 6 is also a screen for displaying and operating the FIB image. The electron beam for an SEM is set to have a large current, the surface of a sample is scanned, the sample is negatively charged, and a resulting SEM image is observed. Then move the cursor to some region on the FIB microscope image and click the mouse. The condition of the electrically charged sample is shown on the right in FIG. 6. The computer 5 then reads and sends the positional information to the FIB lens barrel 1. On receipt of the positional information, the FIB lens barrel 1 controls a deflection mechanism so that the region is irradiated with the beam. The region is then irradiated with a positive ion such as Ga⁺ using the set beam current. During the observation of the SEM, changing contrast then appears at a position irradiated with an FIB. The condition of the regions irradiated is shown on the SEM image on the top left in FIG. 6.

As shown on the bottom left in FIG. 6, the position of a portion with changing contrast is identified by processing the SEM image. The amount of shift between the position irradiated with the ion beam of the ion beam and the position of the electron beam can be identified by measuring the amount of shift X, Y from the center of the SEM image represented by the + mark shown on the bottom left in FIG. 6.

### Sixth Embodiment

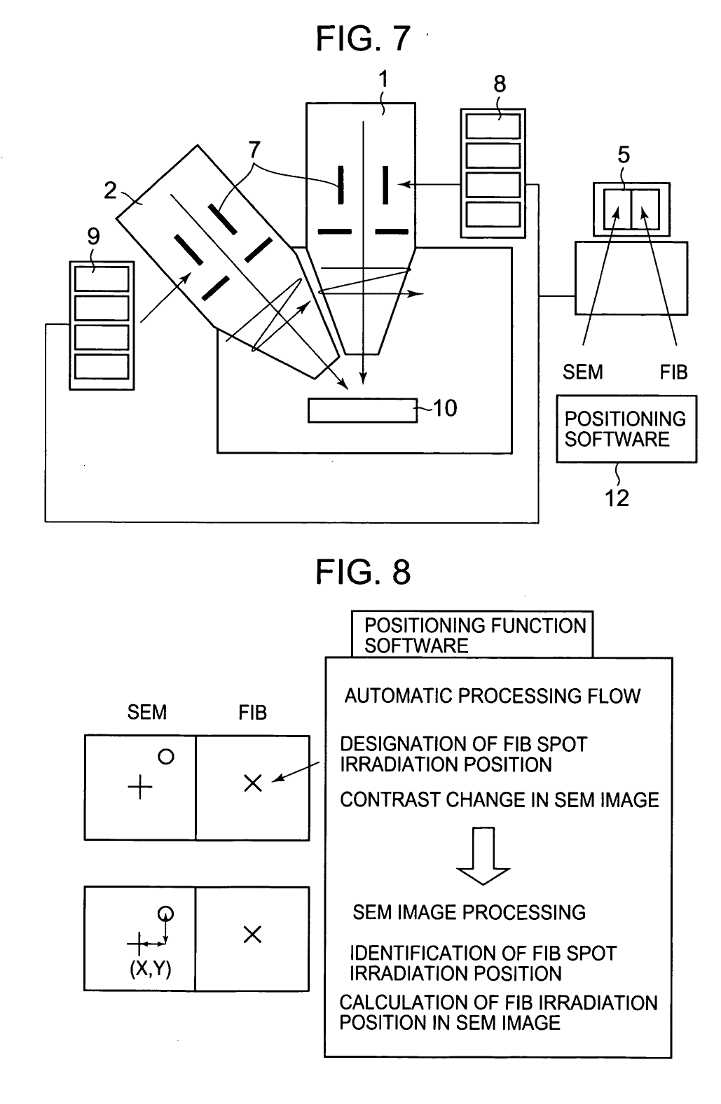

FIG. 7 shows an example of the composite SEM/FIB apparatus according to an alternative embodiment. The apparatus has positioning software built in a control computer, which has a function of automatically performing positioning according to a flow. FIG. 8 shows an explanatory diagram for processing by the positioning software in the control computer. The functions inside the apparatus are similar to those in FIG. 6. The functions described in the flow from beam radiation to the calculation of a position irradiated with an ion beam are automated.

### Seventh Embodiment

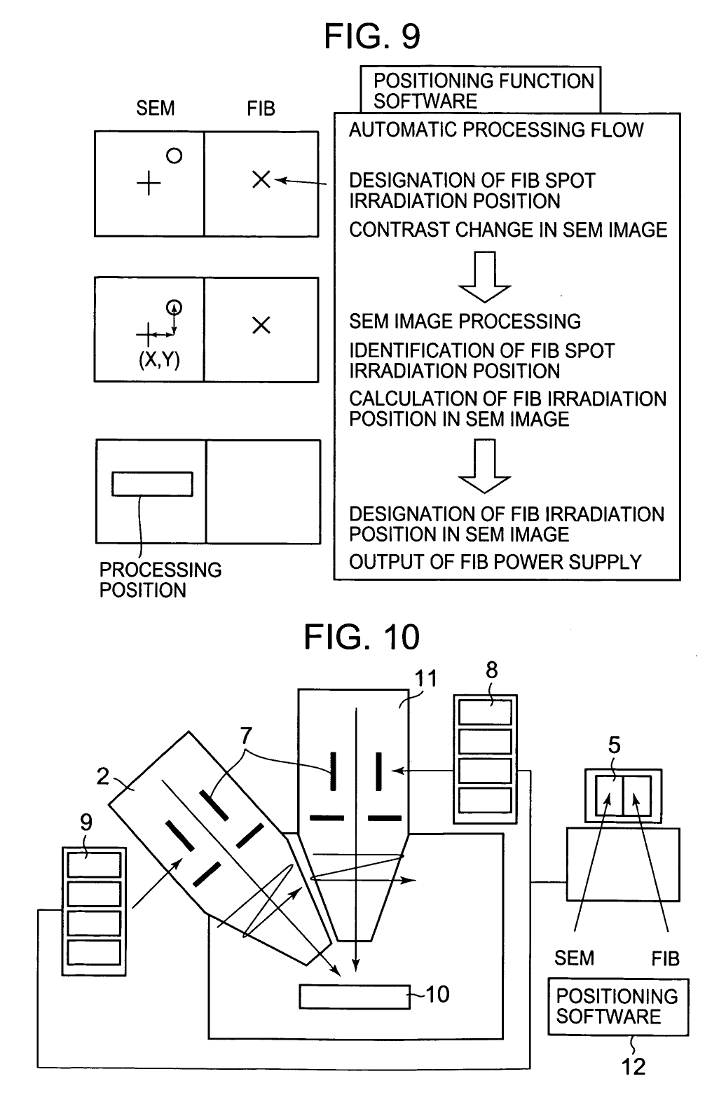

FIG. 9 shows an explanatory diagram of an alternative example of the composite SEM/FIB apparatus according to the invention. The basic configuration of the apparatus is the same as in FIG. 7. The apparatus has positioning software built in a control computer, which has a function of automatically performing positioning according to a flow. FIG. 9 shows a screen used for process in a control computer. FIG. 5 shows the automated functions described earlier.

### Eighth Embodiment

FIG. 10 shows the configuration of an alternative embodiment of the composite SEM/FIB apparatus according to the invention. The apparatus is provided with an FIB lens barrel 11 having a liquid metal ion source. The liquid metal ion source is a high brightness ion source that allows a metal ion to be taken out by placing a liquid metal on the tip of a fine needle and applying a high electric field to the liquid metal. The liquid metal ion source is effective as an ion source for an ion beam lens barrel that requires a beam to be narrowed. Ion source elements can include Ga, In, Pb, Sb, Au and the like. The other basic configuration of the apparatus is the same as in FIG. 7. The apparatus has positioning software built in a control computer, which has a function of automatically performing positioning according to a flow. Like the ion beam lens barrel described earlier, the FIB lens barrel having a liquid metal ion source can be positioned and a position irradiated can be determine.

### Ninth Embodiment

FIG. 11 shows the configuration of an alternative embodiment of the composite SEM/FIB apparatus according to the invention. The apparatus is provided with a variably formed ion beam lens barrel as an ion beam lens barrel. The variably formed ion beam lens barrel will be described below with reference with FIG. 12. For a normal focused ion beam lens barrel, an ion beam is focused on a sample through a lens system composed of a CL (condenser lens) 16 and an OL (objective lens) 17, as shown on the left in FIG. 12. If a microscope image is obtained or drilling is performed on a sample, voltage is applied to a scanning electrode and the sample is scanned. On the other hand, in the variably formed ion beam lens barrel, the aperture not focuses an ion beam the sample but limits the beam, as shown on the right in FIG. 12. A pattern formed by an aperture of an aperture plate 14 having the aperture of an arbitrary shape is projected. An aperture of any shape can be used. The sample is process into a constant patterns by an ion beam projected on the sample. A normal focused ion beam unit can be used as a variably formed ion beam lens barrel by changing lens conditions. In the variably formed ion beam lens barrel described above, it is impossible to observe the surface of a sample under a microscope because scanning is not performed. Therefore, the ion beam cannot be positioned in a specific drilling region. Although not shown in FIG. 11, the configuration of the apparatus including the SEM, control computer, and power supply is the same as in FIG. 7. The apparatus also has a positioning means in the control computer. The FIB lens barrel positioning method by SEM described earlier is similarly applicable to the variably formed ion beam lens barrel.

### Tenth Embodiment

FIG. 13 shows an alternative embodiment of the composite SEM/FIB apparatus according to the invention. The apparatus is characterized by including a plurality of ion beam lens barrels in the same chamber. One of the ion beam lens barrels is a focused ion beam lens barrel and the other is a gas discharge type ion beam lens barrel using a rare gas such as Ar, He, Kr, and Xe. The gas discharge type ion beam lens barrel using a rare gas is used to reduce a damaged layer and an amorphous layer created using a focused ion beam lens barrel. A low acceleration voltage of 1 kV or less is used particularly to reduce a damaged layer. When, in addition, a sample is created using a focused ion beam, an element used as an ion source such as Ga is poured into the sample. However, the gas discharge type ion beam lens barrel using a rare gas can be used to remove mixed layers. Because the gas discharge type ion beam lens barrel provides a large light source, it is impossible to narrow the beam and it is difficult to identify a position irradiated with the beam using the microscope image of the beam. In FIG. 13, the basic configuration of the apparatus including SEM and FIB is the same as in FIG. 7. There is an additional gas discharge type ion lens barrel provided in the chamber. Although the control computer and power supply are not shown, the apparatus has a positioning means in the control computer. The FIB lens barrel positioning method by SEM described earlier is also applicable to the gas discharge type ion lens barrel.

A positioning method according to the present invention allows the alignment of an electron beam with an ion beam with minimum ion beam radiation, making it possible to provide a composite charged particle beam apparatus that reduces damage due to an ion beam, which has been problematic in recent years. The positioning method according to the present invention also makes it possible to provide a composite charged particle beam apparatus that allows the designation of a position irradiated with an electron beam even in a position irradiated with an ion beam, which is difficult to be identified through ion observation under a microscope.

What is claimed is:

1. An irradiation position positioning method of a charged particle beam in a composite charged particle beam apparatus having a plurality of charged particle beam lens barrels disposed in the same vacuum chamber, said method comprising the steps of:
irradiating a surface of a sample with a first charged particle beam to charge a certain region of the sample;
irradiating at a constant position within the charged region with a second charged particle beam having polarity opposite to that of the first charged particle beam; and
observing a change in contrast between the charged region irradiated with the first charged particle beam and the charged region irradiated with the second charged particle beam with a microscope by use of the first charged particle to identify an irradiation position of the second charged particle beam based on the first charged particle beam.

2. An irradiation position positioning method in a composite charged particle beam apparatus according to claim 1, wherein the first charged particle beam is an electron beam and the second charged particle beam is an ion beam.

3. An irradiation position positioning method in a composite charged particle beam apparatus according to claim 1, wherein the first charged particle beam is a focused ion beam and the second charged particle beam is an electron beam.

4. An irradiation position positioning method in a composite charged particle beam apparatus according to claim. 1, wherein after the identification of the position irradiated with the second charged particle beam, the identified irradiated position relative to a center of a first charged particle image is calculated to thereby obtain a shift amount of an irradiated position of the second charged particle beam between in the first charged particle image and in a second charged particle image, and based on the obtained shift amount, a desired region to be irradiated with the second charged particle beam is designated on the first charged particle image.

5. An irradiation position positioning method for a plurality charged particle beams in a composite charged particle beam apparatus having a plurality of charged particle beam lens barrels disposed in a same vacuum chamber, said method comprising the steps of:
irradiating a surface of a sample with a first charged particle beam to charge;
irradiating a certain portion within the charged region with a second charged particle beam;
observing a change in contrast between the region irradiated with the first charged particle beam and the region irradiated with the second charged particle beam under a microscope based on the first charged particle beam to identify the certain position irradiated with the second charged particle beam; and
designating a region to be irradiated with the second charged particle beam on the first charged particle beam microscope image.

6. A composite charged particle beam apparatus comprising:
a first charged particle beam lens barrel;
at least one second charged particle beam lens barrel for radiating a charged particle beam having a polarity opposite to that of the first charged particle beam;
a secondary electron detector for detecting secondary electrons generated from a sample when the sample is irradiated with the charged particle beam;
a vacuum chamber for housing the charged particle beam lens barrel and the secondary electron detector;
each control power supply for each of the first and second charged particle beam lens barrel;
a control computer for controlling the control power supply, processing signals from the secondary electron detector, storing the processed signals as image data together with position information corresponding to the signals, and outputting image signals based on the image data; and
a display for inputting the image signals from the control computer and display an image;
wherein the control computer has means for irradiating a surface of a sample with a first charged particle beam to charge a certain region, irradiating a constant position within the charged region with a second charged particle beam, obtaining image data showing a change in contrast between the charged region irradiated with the first charged particle beam and the charged region irradiated with the second charged particle beam to identify the position irradiated with the second charged particle beam based on the image data obtained.

7. A composite charged particle beam apparatus according to claim 6, the control computer further comprising means for calculating the identified irradiation position relative to a center of a first charged particle image after the identification of the irradiation position of the second charged particle beam, to thereby obtain a shift amount of an irradiated position of the second charged particle beam between in the first charged particle image and in a second charged particle image, and designating a desired region to be irradiated with the second charged particle beam based on the obtained shift amount on the first charged particle image.

8. A composite charged particle beam apparatus according to claim 6, characterized in that of the charged particle beam lens barrels, an ion beam lens barrel for radiating an ion beam is a focused ion beam lens barrel using a liquid metal ion source.

9. A composite charged particle beam apparatus according to claim 6, characterized in that of the charged particle beam lens barrels, an ion beam lens barrel for radiating an ion beam is a variably formed ion beam lens barrel characterized in that the lens barrel projects an aperture pattern.

10. A composite charged particle beam apparatus according to claim 6, wherein the first charged particle beam lens barrel is an electron beam lens barrel and the second charged particle beam lens barrel comprises a focused ion beam lens barrel using a liquid metal ion source and a gas discharge type lens barrel using a rare gas.

11. A composite charged particle beam apparatus according to claim 6, the control computer further comprises means for calculating the identified irradiated position relative to a center of a first charged particle image to thereby calculate an amount of shift between an irradiated position in the first charged particle image and an irradiated position in a second charged particle image, and designating a certain region to be irradiated with the second charged particle beam based on the calculated amount of shift on the first charged particle image.
